(19) United States
(12) Patent Application Publication
(10) Pub. No.: US 2007/0251979 A1
(43) Pub. Date: Nov. 1, 2007

(54) Fastening Element for Friction-Welding to a Flat Component

(75) Inventor: Dieter Mauer, Lollar (DE)

Correspondence Address: BIRCH STEWART KOLASCH & BIRCH, PO BOX 747, FALLS CHURCH, VA, 22040-0747, US

(73) Assignee: EJOT GMBH & CO. KG, BAD LAASPHE (DE)

(21) Appl. No.: 11/632,402

(22) PCT Filed: Jul. 18, 2005
(86) PCT No.: PCT/EP05/07811

§ 371 Date: Apr. 13, 2007

(30) Foreign Application Priority Data
Jul. 16, 2004 (DE) 10 2004 034 497.3
Sep. 9, 2004 (DE) 20 2004 014 071.3

(51) Int. Cl. B23K 20/12

(52) U.S. Cl. 228/2.3

(57) ABSTRACT

The invention relates to a fastening element with a face, which has a concentric annular bead (3), for being friction welded to a flat component (12, 26) by rotational force acting upon the fastening element and a pressing force directed toward the component (12, 26). The annular bead (3) has, in the area of its greatest height (6), a concentric line of contact with the component (12, 26) and is a part of a flange (4), which comprises both the annular bead (3) as well as, outside of the annular bead (3), a concentric groove (7) with an outer wall (25) for repelling rubbed-off parts arising during friction welding, and has a central recess (8) for accommodating the rubbed-off parts, whereby the flange (4), together with its side facing away from the annular bead (3), forms an opposite surface (5) for the pressing force directed toward the component (12, 26) and, together with its outer surface, forms a driver for the rotational force.

The invention relates to a fastening element with a front face having a concentric annular ring for friction-welding to a flat component through rotational force acting on the fastening element and pressing force against the component.

Such a fastening element is presented in DE 199 27 369 A1 Figure g, wherein said fastening element is a stud with a flange provided at one end of the stud, said flange having a concentric annular ring on its side facing away from the stud. Said annular ring forms the radial end of the flange and surrounds a central recess. The friction surface of the annular ring is flat, this resulting in an annular flat friction surface on the stud, said friction surface being able to be attached with considerable cross-section to a flat component through friction-welding. To be sure, during the friction-welding operation through rotation of the fastening element and pressing against a component, the known stud with its relatively large friction surface allows the required heat to be generated for the part-melting of the contact surfaces. However, it has the disadvantage that, during rotation of the fastening element and pressing against the component, there are produced radial shear forces, the consequence of which is that, in addition to rotation, the stud also rhythmically undergoes a deflection which imparts a considerable unsteadiness to the friction-welding operation.

Furthermore, U.S. Pat. No. 4,850,772 discloses a stud which is to be attached by friction-welding to a component, the front face of said stud forming the surface which is to be joined by friction-welding to the respective component. The stud has a flange spaced from the front face, said flange being designed to transmit the rotational force and the pressing force, such that its side facing away from the front face of the stud is slightly conical in form and is provided with successive flutes which are oriented radially with their ridges. Said thus oriented flutes together form the aforementioned cone and serve to be received by a correspondingly shaped chuck which then takes up the rotational force via the flutes and the pressing force via the radial extent of the flange and transmits said forces via the shank of the stud to the front face thereof for friction-welding. Since, in the friction-welding process which underlies the stud, it is necessary to apply both considerable rotational forces and also pressing forces, the fluted design of the aforementioned surface of the flange may mean that the slopes of the individual flutes impart to the chuck of the employed friction-welding device the tendency to be rhythmically forced away from the flange, which may result in a shaking motion, above all in the axial direction, this being detrimental for the friction-welding operation.

The object of the invention is to design the aforementioned fastening element such that, with uniform guiding, it has the tendency automatically to center itself during rotation. The object of the invention is achieved in that, in the region of its greatest elevation, the annular ring has a concentric contact line in relation to the component and is part of a flange, wherein said flange comprises both the annular ring and also, outside of the annular ring, a concentric groove with an outer wall for repelling abraded material arising during the friction-welding operation as well as a central indentation for receiving the abraded material, wherein, with its side facing away from the annular ring, the flange forms a mating surface for the pressing force against the component and, with its outer surface, forms a driver for the rotational force.

By reason of this design of the annular projection with a concentric contact line, when the fastening element is rotated and pressed against a flat component, there is immediately formed in the component an impression line which follows the contact line, said impression line becoming deeper as the friction-welding operation progresses and therefore leading automatically to the self-centering of the fastening element during the friction-welding operation. In the process, the concentric groove, surrounding the annular ring, with its outer wall and the central indentation ensures that the abraded material arising during friction-welding, more especially melt residues and dirt particles, is repelled or taken up, said abraded material thus being automatically removed from the actual friction-welding region and therefore being unable to disturb the friction-welding operation. Because the annular ring is integrated into the flange, the flange is advantageously able to perform a plurality of functions, namely also the transmission of the rotational force and the pressing force, this allowing a correspondingly compact design of the fastening element according to the invention. The flange is capable of absorbing the required pressing forces which must act during friction-welding and which are transmitted from the rotating fastening element into the friction-welding zone on the component. The flange is at the same time used as a driver, particularly when it is in the form of a hexagon, this being of advantage for driving the fastening element by means of a rotating chuck of a corresponding tool, wherein the flange forms, with its side facing away from the annular ring, a mating surface for the chuck of a friction-welding device, wherein, as described hereinbefore, said chuck transmits to the welding site a pressing force exerted on the flange.

The annular ring may advantageously be of convex cross-section. Thanks to this design, when the annular ring contacts the component there results a concentric narrow contact line which automatically results in the aforementioned centering of the fastening element during the friction-welding operation. In this connection, the convex design also has a compensating effect in the event of the fastening element not having been positioned accurately at a right angle on the component.

Alternatively, however, other cross-sectional designs of the annular ring are possible, for example such that the annular ring is bounded in cross-section by a convex, concentrically circular conical surface, said conical surface terminating towards the outside in the contact line at the outer edge of the annular ring. In this case, the concentric contact line is placed as far as possible to the outer edge of the annular ring, this further intensifying the centering effect of the contact line.

The fastening element may suitably be, for example, in the form of a stud or a nut.

When in the form of a nut, the fastening element may advantageously be designed in the form of a ground contact in that one side thereof is in the form of a welding side having a concentric annular ring for the friction-welding operation and the other side thereof is in the form of a contact-making side for the electrical contacting of an electrical conductor such that the contact-making side has a projection concentric with respect to the nut body, the front face of said projection forming the contact-making surface and the round outer edge of said projection being overtopped and sealed by the head of a pre-mounted screw.

For the attachment and friction-welding of the friction-welding nut, said nut is provided with the concentric annular ring, which, during the friction-welding operation, results in a concentric contact line in relation to the respective component, this leading to self-centering during rotation of the friction-welding nut while being subjected to pressing force.

The concentric projection, which forms the later contact-making site, is initially covered, during attachment of the friction-welding nut by friction-welding, by the head of the pre-mounted screw, wherein, owing to its pressing against the projection, said head at the same time ensures the sealing of the contact-making side, with the result that said contact-making side constantly remains free from contaminants until the friction-welding nut has finally been attached, the pre-mounted screw unscrewed and, with it, an electrical conductor screwed down on the friction-welding nut. In this connection, therefore, the pre-mounted screw serves, on the one hand, to cover and keep clean the sensitive contact-making side of the friction-welding nut during attachment of the friction-welding nut and a subsequent painting process and also during the fastening of an electrical conductor to the contact-making side of the friction-welding nut, with the result that the contact-making side of the friction-welding nut is always protected against contamination and corrosion, thereby guaranteeing sure contact-making.

The concentric projection is advantageously of such design that the diameter of its outer edge is smaller than the smallest diameter of the underside of the head of the screw. In this case, the head of the screw safely overtops the projection, with the result that the entire surface thereof is constantly protected against contamination.

In order to guarantee particularly good contact-making with simultaneous securing of the screw and sealing of the region of the contact-making site, the front face of the projection is advantageously in the form of a flat-concave cone, wherein, when the screw head is pressed on, the round outer edge of said cone forms a linear contact region of increased contact pressure. By reason of this design, an electrical conductor, more particularly a cable lug, is pressed particularly firmly against the projection in the region of the round outer edge thereof, this guaranteeing sure contact-making, there being formed, namely, a linear contact region which is characterized by an increased contact pressure. The flat-concave cone, as receptacle for the electrical conductor, additionally ensures that the established connection is subject to a self-locking effect, since the flat-concave region draws the conductor, as it were, into its inner region, thereby affording protection against its working loose. Furthermore, there is the advantageous effect that, owing to the particularly high pressure at the outer edge of the projection, there is an especially strong sealing effect towards the inside, this sealing the contact-making site against ingress of moisture and thus providing the thread with particularly effective protection against corrosion.

Where the fastening element is in the form of a stud with a threaded shank, said threaded shank can, through a transition to the flange, be used as a region for engagement of the stud by a chuck, said region forming a coaxial cylindrical neck adjoining the flange, wherein said neck, of larger diameter than the threaded shank, transitions into the mating surface and, upon engagement by the chuck, allows the precise centered rotation of the stud upon pressing against the component and, also with regard to its diameter, can easily be manufactured with small tolerance.

During formation of the friction-welded connection, also the region inside the ring of melted-on material is heated, which can lead, especially if contaminations or coatings are present, to vaporization. Such vapors are included by the contact between the component and the annular ring. In order to allow such vapors to be discharged, the annular ring may be provided with one or more radial grooves, the depth of which corresponds to the friction-welded connection. Said radial grooves are so narrow that, while causing virtually no impairment to the strength of the friction-welded connection, they ensure that there is no undesired overpressure inside the friction-welded connection as a consequence of any vapors. In addition, the radial grooves may also have the desired effect of scraping off any coating on the component prior to commencement of the actual friction-welding operation.

Illustrative embodiments of the invention are presented in the drawings, in which:

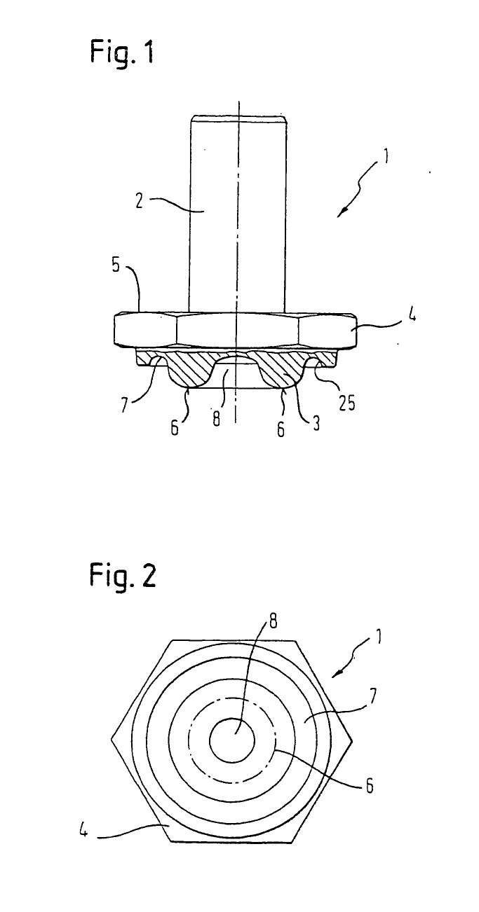

FIG. 1 shows a fastening element in the form of a stud with a convex annular ring in side elevation, partially in section;

FIG. 2 shows the stud in a top plan view of the annular ring;

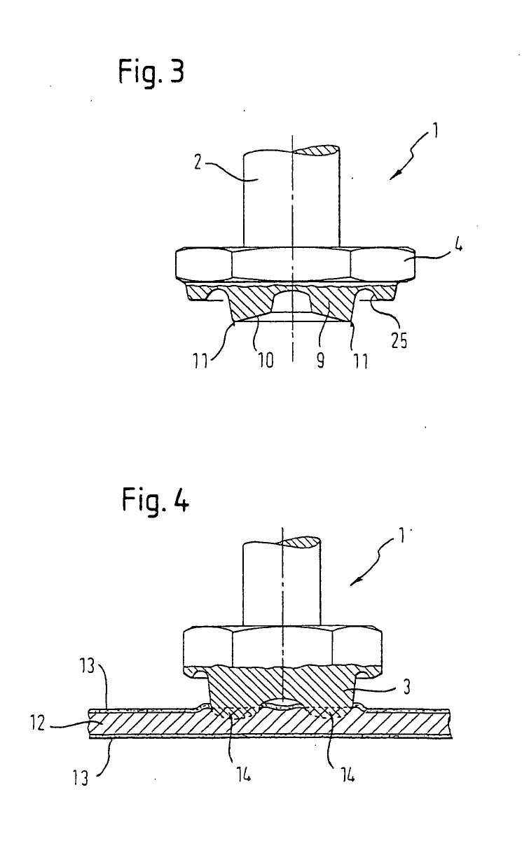

FIG. 3 shows a similar stud with a concentrically circular conical surface on the annular ring, partially in section;

FIG. 4 shows a fastening element in the form of a stud, welded onto a component;

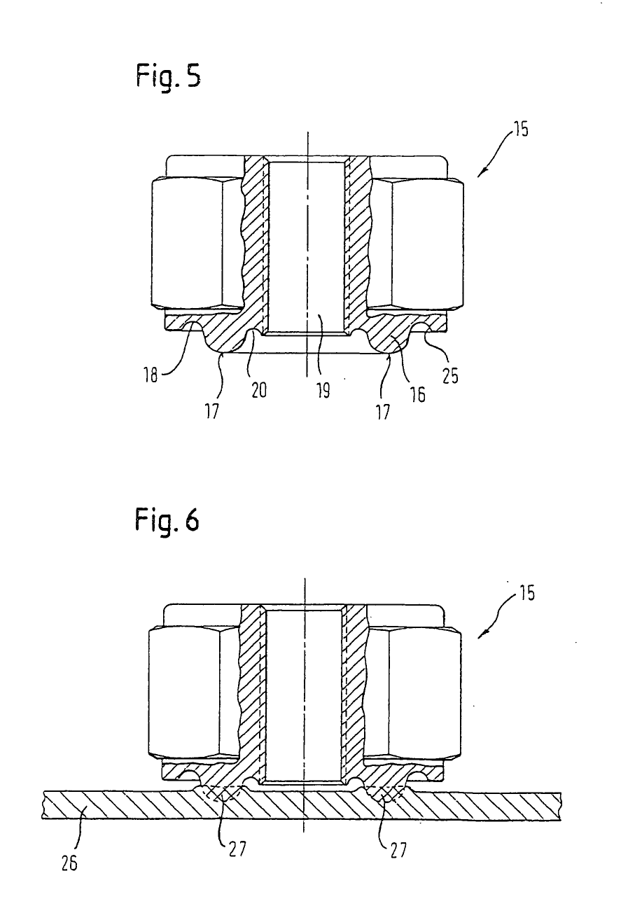

FIG. 5 shows a fastening element in the form of a nut;

FIG. 6 shows the nut from FIG. 5, welded onto a component;

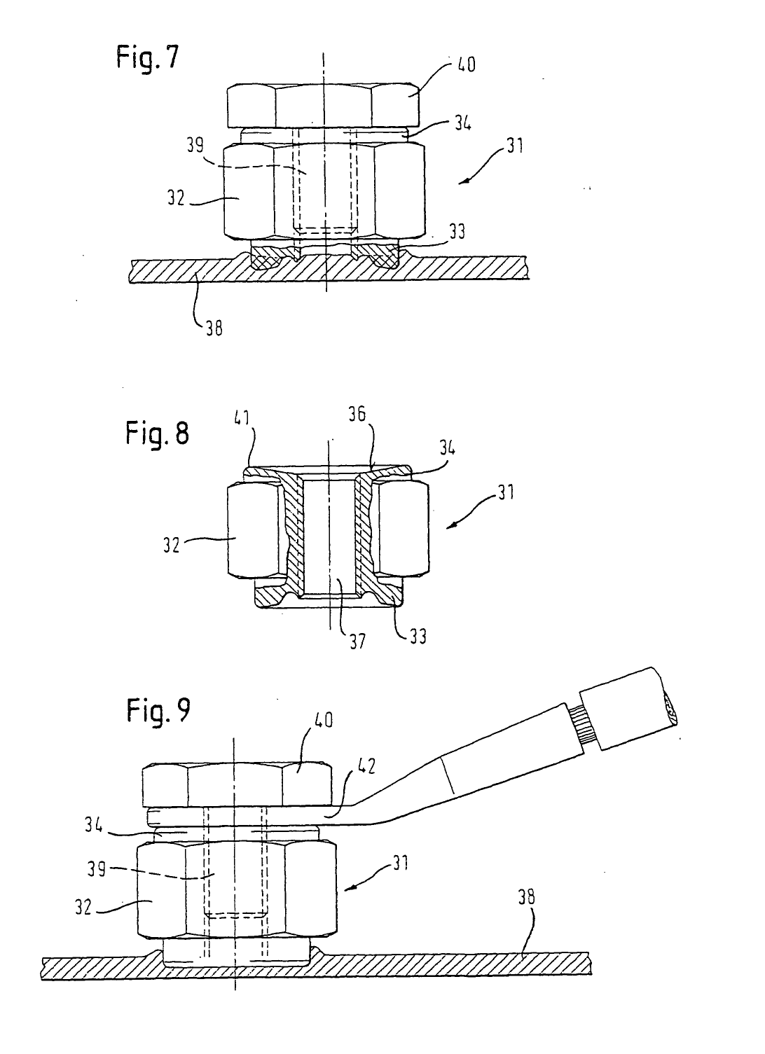

FIG. 7 shows the friction-welding nut welded to a metal plate and with pre-mounted screw;

FIG. 8 shows the friction-welding nut on its own;

FIG. 9 shows the friction-welding nut with screwed-on cable lug;

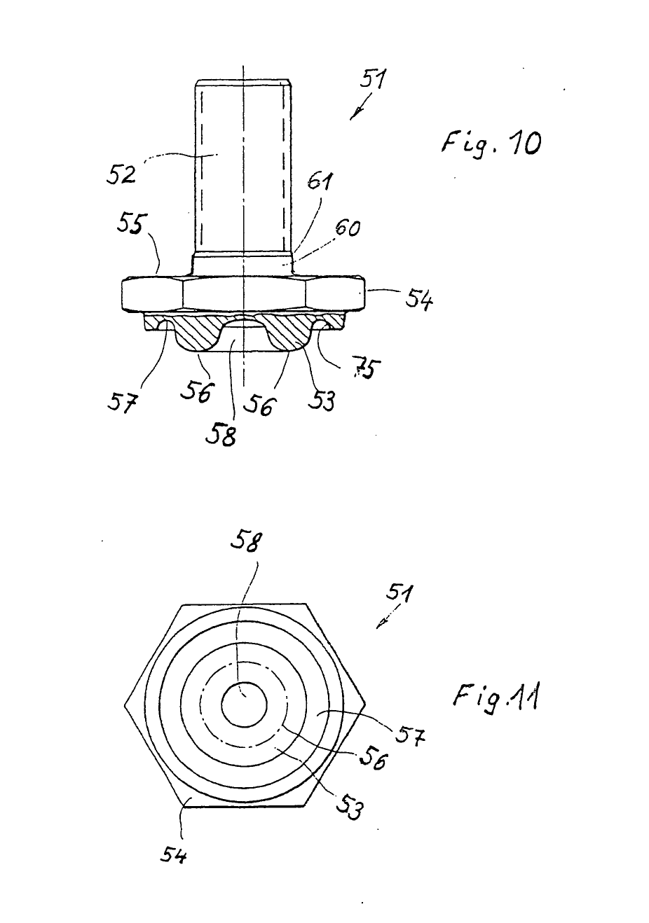

FIG. 10 shows a fastening element in the form of a stud with a convex annular ring in side elevation, partially in section;

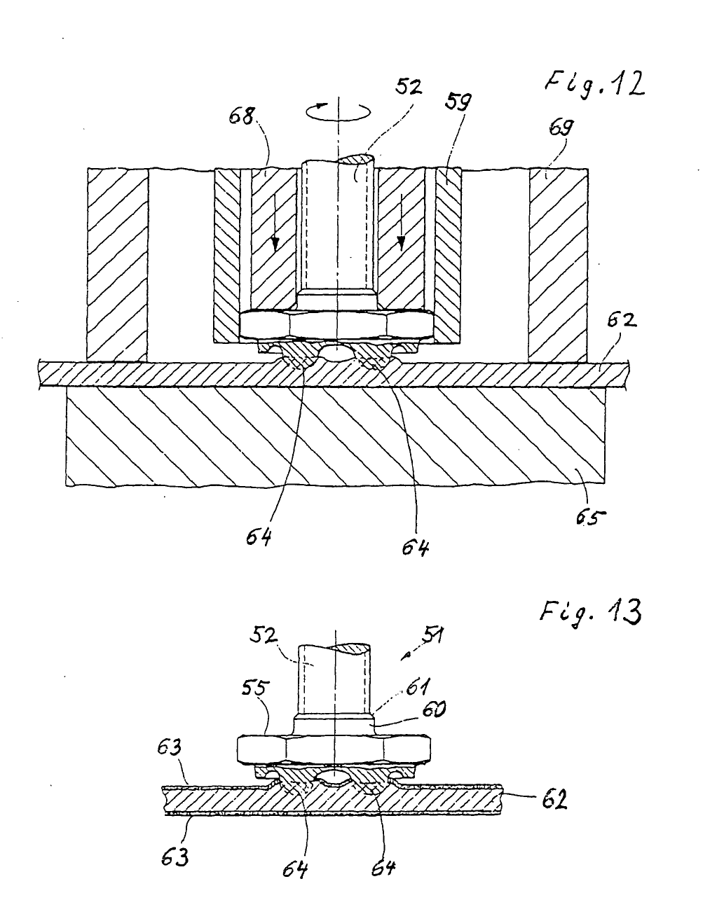

FIG. 11 shows the stud in a top plan view of the annular ring;

FIG. 12 shows the chuck, with the stud having been engaged by said chuck and pressed against a component;

FIG. 13 shows a stud connected by friction-welding to a coated component;

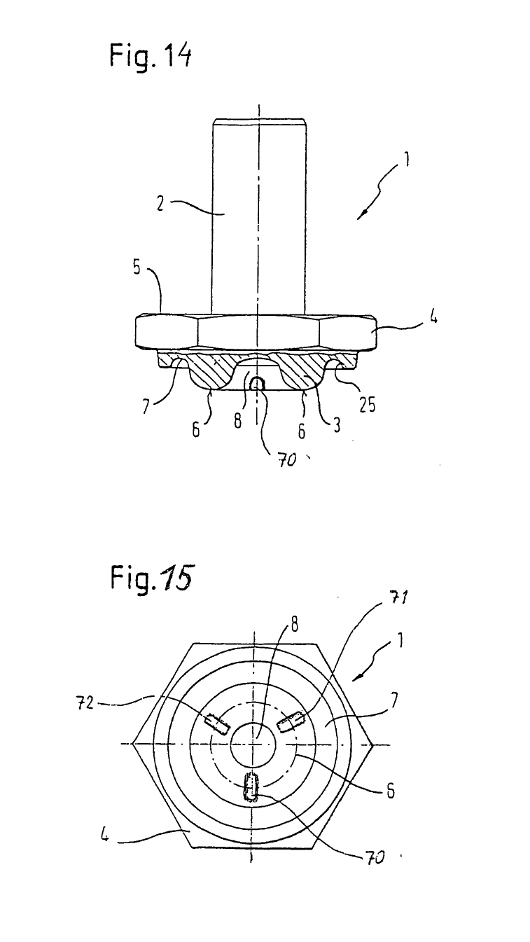

FIG. 14 shows a fastening element in the form of a stud according to FIG. 1 in side elevation with a radial groove;

FIG. 15 shows a fastening element in the form of a stud in a top plan view of the annular ring, said annular ring here being provided with three radial grooves.

FIG. 1 presents a fastening element in the form of a stud 1, said stud 1 being provided on one of its sides with the smooth shank 2 and on its other side with the annular ring 3 (shown in section) as part of the flange 4. The flange 4 is in the form of a hexagon with respect to its outer surface. For the friction-welding operation, the stud 1 is clamped into a suitably shaped chuck of a known friction-welding device, for which the hexagon of the flange 4 serves as an advantageous driver for taking up the required large rotational force. During the friction-welding operation, the chuck (not shown) presses on the rear surface 5 of the flange 4, as a result of which the annular ring 3 is then pressed against a flat component (not shown in FIG. 1) with the required pressing force. Such a flat component is presented in FIG. 4. When the stud 1 is pressed against a component, the annular ring 3 contacts with the region of its greatest elevation 6 (shown as a dash-dotted line in FIG. 2), there being formed a very narrow concentric contact line, which ensures that, during pressing against the component and during rotation of the stud 1, there is automatically a self-centering of the rotational movement.

FIG. 2 presents the stud 1 in a top plan view of the side of the stud with the annular ring 3. In FIG. 2, as stated above, the contact line 6 is presented by the dash-dotted line 6.

As is further made apparent by FIG. 1, the annular ring 3 is bounded on one side by the concentric groove 7 and on the other side by the central indentation 8, the outer wall 25 forming a surface for repelling abraded material using the centrifugal force and the indentation 8 forming a receiving space for the abraded material (melt residues and dirt particles), which abraded material is then unable to disturb the actual friction-welding operation.

FIG. 3 presents a variation on the design of a stud 1 according to FIG. 1, FIG. 3 showing the cross-section of the annular ring, which is here identified by reference character 9. The annular ring 9 is provided towards the inside with the convex circular conical surface 10, which terminates towards the outside in the concentric contact line 11. Said contact line 11, disposed far outside on the annular ring 9, ensures in particular manner that the stud 1 is self-centering during rotation thereof

FIG. 4 presents the stud 1 from FIG. 1, welded onto the flat component 12. The flat component is here formed by a thin coated metal plate, the coatings of which are identified by reference character 13. As can be seen, a portion of the convex annular ring 3 has penetrated into the material of the component 12 and has, in the region 14, welded in pore-free manner with the material of the component 2.

FIG. 5 shows a fastening element in the form of the nut 15, wherein, on one of its sides, said nut 15 is similar in design to the stud 1 according to FIG. 1. On the side in question, the nut 1 has the convex annular ring 16, on which is then formed the contact line 17 during the friction-welding operation. The groove 18 is provided next to the annular ring 16. Also provided between the annular ring 16 and the through-hole 19 is the inner groove 20, which directs any abraded material away from the through-hole 19.

FIG. 6 presents the nut 15 from FIG. 5, this time welded to the flat component 26, which is here formed by a thin metal plate. As can be seen, a portion of the convex annular ring 16 has penetrated into the material of the component 26 and has, in the region 27, welded with the material of the component 26.

FIG. 7 shows the friction-welding nut 31 (see also FIG. 8), welded to the metal plate 38. During the friction-welding operation, the friction-welding nut 31 is in known manner pressed against the metal part 38, wherein the concentric projection 33 presses against the respective surface of the metal part 38, is liquefied by being heated and, finally, welds with the metal part 38.

The friction-welding nut 31 is provided with the pre-mounted screw 39, the screw head 40 of which presses against the outer edge 41 (visible in FIG. 8) of the cone 36, forming at that site a particularly effective seal because of the narrow, linear contact, with the consequence that, if a coating, e.g. a layer of paint, has to be applied with the friction-welding nut 31 having been welded on, said coating is unable to penetrate into the region of the cone 36 which serves as the contact-making site.

The friction-welding nut 31 presented in FIG. 8 comprises the nut body 32, one side of which, as the welding side, is provided with the concentric annular ring 33. The other side of the friction-welding nut 31 forms the contact-making side, which, for this purpose, has the concentric projection 34, which is stamped out of the nut body 32. The round outer edge of the projection 34 is of such diameter that it is overtopped by the head of the pre-mounted screw 39, this being more fully explained with reference to FIG. 7. The projection 34 is provided on its front face with the flat-concave cone 36, which ensures especially good contact-making and sealing when an electrical conductor is screwed on. The cone 36 forms the contact-making site for a conductor which is to be screwed on (see FIG. 9). The friction-welding nut 31 is additionally provided with the internally threaded through-hole 37; furthermore, the outer surface of the nut body 32 is in the form of a hexagon, with the result that the friction-welding nut 31 can be securely engaged by a suitable tool for the friction-welding operation and can be pressed against a component which is to be welded on.

FIG. 9 shows the friction-welding nut 31, welded to the metal part 38, as presented in FIG. 1, wherein the screw 39, still pre-mounted in the phase shown in FIG. 8, now serves to screw a cable lug 42 on the friction-welding nut 31, the cable lug 42 being pressed against the cone 36 and more particularly against the edge 41 thereof, this resulting in especially sure contact-making and in secure sealing, because, during said pressing on, the material of the cable lug 42 is pressed, at least in part, into the cone 36, thereby additionally becoming especially effectively locked against rotation therein.

FIG. 10 presents a fastening element in the form of the stud 51, said stud 51 being provided, on its one side, with the threaded shank 52 and, on its other side, with the annular ring 53 (shown in section) as part of the flange 54. The flange 54 is in the form of a hexagon with respect to its outer surface. For the friction-welding operation, the stud 51 is clamped into a suitably shaped chuck of a friction-welding device (see FIG. 12), for which the hexagon of the flange 54 serves as an advantageous driver for taking up the required large rotational force. During the friction-welding operation, the chuck (not shown in FIG. 10) presses on the rear surface 55 of the flange 54, which surface serves as the mating surface 55 for the pressing force, this then allowing the annular ring 53 to be pressed against a flat component (not shown in FIG. 10) with the required pressing force. Such a flat component is presented in FIGS. 12 and 13. When the stud 51 is pressed against a component, the annular ring 53 contacts with the region of its greatest elevation 56 (shown as a dash-dotted line in FIG. 11), there being formed a very narrow concentric contact line which ensures that, during pressing against the component and during rotation of the stud 51, there is automatically a self-centering of the rotational movement.

Provided between the threaded region of the threaded shank 52 and the flange 54 is the neck 60, which is of cylindrical form and extends coaxially with respect to the stud 51, with the result that the neck 60 offers the ideal guiding region for the application of a chuck, which thus, in the case of precisely centered rotation, imparts a perfectly true rotation to the stud. In the presented design, the neck 60 is disposed radially relatively close to the contact line in the region of the elevation 56, with the result that this, too, provides advantageous guiding of the region with the annular ring 53, said region being required for the friction-welding operation. The transition from the threaded shank 52 to the neck 60 is formed by the conical slope 61, which facilitates the application of a chuck.

FIG. 11 presents the stud 51 in a top plan view of the side of the stud with the annular ring 53. In FIG. 11, the contact line 56 is, as stated above, represented by the dash-dotted line 56.

As is further made apparent by FIG. 10, the annular ring 53 is bounded on one side by the concentric groove 57 and on the other side by the central indentation 58, the outer wall 75 forming a surface for repelling abraded material using the centrifugal force and the indentation 58 forming a receiving space for the abraded material (melt residues and dirt particles), which abraded material is then unable to disturb the actual friction-welding operation.

FIG. 12 presents the stud 51, engaged by a chuck in the phase of rotation of the stud and pressing against the component 62, which chuck is partially shown in FIG. 12 and presses the component 62 through the downholder 69 against the abutment 65. The chuck comprises the annular receptacle 59, which snugly embraces the flange 54 (which is of hexagonal profile) and which is set in rotation by a rotary drive (not shown) during the friction-welding operation, the stud 51 being centrally engaged in its region with the cylindrical neck 60 by the tubular thrust member 68, with the result that, during rotation, it is ensured by the coaxial, cylindrical neck 60 and the thrust member 68 that the annular ring 53 of the stud rotates perfectly truly, i.e. without any lateral runout. By reason of the rotation and pressing-on of the stud 51 with its annular ring 53, there occurs such heating at the contact sites of annular ring 53 and component 62 that, finally, friction-welding takes place in the region 64 with the material of the component 62.

FIG. 13 presents the stud 51 from FIG. 10, welded onto the flat component 62. The flat component is here formed by a thin coated metal plate, the coatings of which are identified by reference character 63. As can be seen, a portion of the convex annular ring 53 has penetrated into the material of the component 62 and has, in the region 64, welded in pore-free manner with the material of the component 62.

FIG. 14 presents the fastening element from FIG. 1, in this case with the addition of the radial groove 70, which is recessed into the annular ring 3 in the region of the greatest elevation 6. The radial groove 70 is of only small depth, said depth, however, corresponding approximately in its extent to the friction-welded connection, with the result that, upon forming of the friction-welded connection, any gases occurring within the annular ring 3 are able to escape through the groove 70. Owing to its small dimensions, the radial groove 70 does not adversely affect the friction-welded connection, it at any rate even assisting the friction-welding operation in that any contaminations or coatings on the component are scraped off by its edges.

FIG. 15 presents the same fastening element in a top plan view of the side of the fastening element with the annular ring 3. As can be seen, three radial grooves 70, 71, 72 are recessed into the annular ring 3. However, it should be pointed out that it is also possible to provide more or fewer radial grooves, depending on the materials involved in the required friction-welded connection.

1. Fastening element with a front face having a concentric annular ring (3) for friction-welding to a flat component (12, 26) through rotational force acting on the fastening element and pressing force against the component (12, 26), wherein, in the region of its greatest elevation (6), the annular ring (3) has a concentric contact line in relation to the component (12, 26) as well as a central indentation (8) for receiving the abraded material and is part of a flange (4), characterized in that the flange (4) comprises both the annular ring (3) and also, outside of the annular ring (3), a concentric groove (7) with an outer wall (25) for repelling and taking up abraded material arising during the friction-welding operation, wherein, with its side facing away from the annular ring (3), the flange (4) forms a mating surface (5) for the pressing force against the component (12, 26) and, with its outer surface, forms a driver for the rotational force.

2. Fastening element according to claim 1, characterized in that the annular ring (3) is of convex cross-section.

3. Fastening element according to claim 1, characterized in that the annular ring (9) is bounded in cross-section by a convex, concentrically circular conical surface (10), said conical surface (10) terminating towards the outside in the contact line at the outer edge (11) of the annular ring (9).

4. Fastening element according to claim 1, characterized in that the driver is in the form of a hexagon.

5. Fastening element according to claim 1, characterized in that said fastening element is in the form of a stud (1).

6. Fastening element according to claim 1, characterized in that said fastening element is in the form of a nut (15).

7. Fastening element according to claim 6, characterized in that said fastening element is in the form of a ground contact, wherein one side of said ground contact is in the form of a welding side having the concentric annular ring (33) for the friction-welding operation and the other side thereof is in the form of a contact-making side for the electrical contacting of an electrical conductor such that the contact-making side has a projection (34) concentric with respect to the nut body (32), the front face of said projection (34) forming the contact-making surface and the round outer edge of said projection (34) being overtopped and sealed by the head (40) of a pre-mounted screw (39).

8. Fastening element according to claim 7, characterized in that the diameter of the outer edge of the projection (34) is smaller than the smallest diameter of the underside of the head (40) of the screw (39).

9. Fastening element according to claim 7, characterized in that the front face of the projection (34) is in the form of a flat-concave cone (36), wherein, when the screw head (40) is pressed on, the round outer edge (41) of said cone (36) forms a linear contact region of increased contact pressure and sealing.

10. Fastening element according to claim 5, characterized in that the stud (51) has a threaded shank (52), said threaded shank (52) transitioning into the mating surface (55) via a coaxial, cylindrical neck (60), adjoining the flange (54), of larger diameter than the threaded shank (52).

11. Fastening element according to claim 1, characterized in that, in the region of its greatest elevation (6), the annular ring (3) has at least one radial groove 70, 71, 72, the depth of which corresponds at least to the friction-welded connection.

12. Fastening element according to claim 2, characterized in that the driver is in the form of a hexagon.

13. Fastening element according to claim 3, characterized in that the driver is in the form of a hexagon.

14. Fastening element according to claim 2, characterized in that said fastening element is in the form of a stud (1).

15. Fastening element according to claim 3, characterized in that said fastening element is in the form of a stud (1).

16. Fastening element according to claim 4, characterized in that said fastening element is in the form of a stud (1).

17. Fastening element according to claim 2, characterized in that said fastening element is in the form of a nut (15).

18. Fastening element according to claim 3, characterized in that said fastening element is in the form of a nut (15).

19. Fastening element according to claim 4, characterized in that said fastening element is in the form of a nut (15).

20. Fastening element according to claim 8, characterized in that the front face of the projection (34) is in the form of a flat-concave cone (36), wherein, when the screw head (40) is pressed on, the round outer edge (41) of said cone (36) forms a linear contact region of increased contact pressure and sealing.
